(19) United States
(12) Patent Application Publication
(10) Pub. No.: US 2021/0251431 A1
(43) Pub. Date: Aug. 19, 2021

(54) NON-SLIP CUTTING MAT AND METHOD OF FORMATION

(71) Applicant: Epoca International, Inc., Boca Raton, FL (US)

(72) Inventor: Ryan T. Wirth, Boca Raton, FL (US)

(73) Assignee: Epoca International, Inc., Boca Raton, FL (US)

(21) Appl. No.: 17/176,990

(22) Filed: Feb. 16, 2021

Related U.S. Application Data
(60) Provisional application No. 62/976,327, filed on Feb. 13, 2020.

(51) Int. Cl. A47J 47/00; B32B 25/04

(52) U.S. Cl. CPC A47J 47/005; B32B 2307/744; B32B 25/04

(57) ABSTRACT

A polymeric non-slip cutting mat that includes an integral layup forming a body and having a base layer of a polymeric material, at least one print layer of a polymeric material with a friction-inducing characteristic and decorative indicia disposed thereon, and a bonding print layer having a polymeric bonding agent and interposed between the base layer and the at least one print layer with the decorative indicia disposed thereon.

### FIELD OF THE INVENTION

The present invention relates to a polymeric non-slip cutting mat and, more particularly relates to a polymeric non-slip cutting mat and method of formation.

### BACKGROUND OF THE INVENTION

Typically, cutting mat assemblies are composed of plain thermoplastic polymeric material with a gripping surface or texture adhered to the underside. These non-slip features, however, are not always sufficient and pose a safety risk and inconvenience to users who must be wary of the moving assembly and continuously readjust it for optimum comfort and safety when dicing food products. Further, such cutting mat assemblies generally have a generic gripping surface or texture adhered to the underside that comes in one style or design. Not only is the design of such gripping surfaces or textures generic, and thereby not customizable, but the other component parts of such cutting mat assemblies are sometimes not transparent. As such, the gripping surfaces or textures may not be visible to the user through the cutting mat assembly when the same is in use. Moreover, those known mats also do not allow cutting thereon without damaging the printed ornamental design.

Therefore, a need exists to overcome the shortcomings with the prior art as discussed above.

### SUMMARY OF THE INVENTION

To enhance and improve existing non-slip cutting mat assemblies, the present invention provides a non-slip cutting mat assembly that overcomes the heretofore-mentioned disadvantages of the heretofore-known products of this general type and that allows consumers to cut produce and other foodstuffs on a non-slip cutting mat defined by a customizable decorative and functional design. Due to the placement of the decorative indicia on the underside of the cutting mat assembly, users can cut food products on the cutting surface without marring the decorative indicia therein.

With the foregoing and other objects in view, there is provided, in accordance with the invention, a non-slip cutting mat assembly comprising one polypropylene or other thermoplastic polymer composition base layer, at least one print layer with decorative indicia disposed thereon, and a bonding print layer having a polymeric bonding agent and interposed between the base layer and the at least one print layer with decorative indicia disposed thereon.

In the current embodiment of this invention, the non-slip cutting mat assembly is comprised of two or more print layers and a polypropylene or other thermoplastic polymer composition base layer, wherein all layers are adjoined to one another via a curing process.

The base layer is comprised of a polypropylene or other thermoplastic polymer composition, serving as a cutting surface during use.

In an exemplary embodiment of the present invention, the at least one print layer with decorative indicia disposed thereon and the bonding print layer are substantially comprised of a polysiloxane composition, generally known as silicone, but may be of another substantially equivalent material or substrate in alternate embodiments.

The at least one print layer with decorative indicia disposed thereon, is of a polymeric material having a friction-inducing characteristic or property which helps to reduce occurrences of inadvertent movement of the cutting mat assembly. The at least one print layer further aids in the visual presentation of the cutting mat assembly by virtue of its decorative indicia, e.g., colors, designs, and decorative features. The transparent property of the polypropylene or other thermoplastic polymer composition base layer also assists in the visual presentation of the cutting mat assembly, making it possible for users to view the decorative indicia on the underlying print layers through the polypropylene or other thermoplastic polymer composition base layer at the top of the cutting mat assembly. The decorative indicia on the print layers may be customized to suit the taste of consumers or manufacturers.

In accordance with the present invention, the method of forming a non-slip cutting mat comprises the steps of providing a substrate forming a base layer of a polymeric material and defining an upper surface of a body of an integral layup, applying a polymeric bonding agent to the base layer to form an integral layup, curing the integral layup at a temperature and for a period of time sufficient to cure the integral layup without plastic deformation, applying at least one print layer of a polymeric material with a friction-inducing characteristic and decorative indicia disposed thereon, on the integral layup, and curing the integral layup at a temperature and for a period of time sufficient to cure the integral layup without plastic deformation.

Although the invention is illustrated and described herein as embodied in a non-slip cutting mat assembly and method of formation, it is, nevertheless, not intended to be limited to the details shown because various modifications and structural changes may be made therein without departing from the spirit of the invention and within the scope and range of equivalents of the claims. For example, some steps may be combined or consolidated to achieve the same intended function or purpose in fewer steps. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper”, “lower”, “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device. Furthermore, there is no intention to be bound by any expressed or implied theory presented in the preceding technical field, background, brief summary or the following detailed description.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a perspective view image of a non-slip cutting mat assembly, in accordance with one embodiment of the present invention;

FIG. 2 is an exemplary schematic diagram depicting a preferred layup of the non-slip cutting mat assembly shown in FIG. 1;

FIG. 3 is a perspective view of several exemplary embodiments of the non-slip cutting mat assembly shown in FIG. 1;

FIG. 4 is a block diagram of a method of formation of a non-slip cutting mat, in accordance with the present invention; and

FIG. 5 is a schematic diagram depicting a preferred layup of the non-slip cutting mat assembly, in accordance with the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

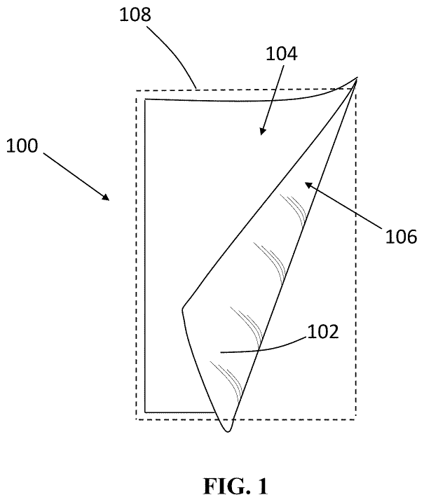

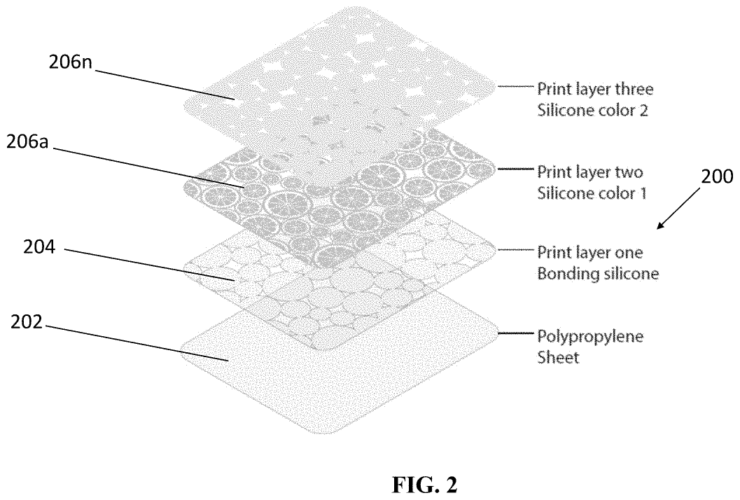

The present invention provides a novel non-slip cutting mat assembly 100, hereafter “the cutting mat assembly 100”, and method of formation. Embodiments of the invention provide the cutting mat assembly 100, as best seen in FIGS. 1-2, include an integral layup 200 forming a body 102, wherein the body has multiple layers enabling a cutting mat that is both functional, safe, and ornamental. The body includes an upper surface 104, for cutting by the user, and a lower friction-inducing surface 106, for supporting the mat on a support surface. The lower surface can be seen opposing the upper surface of the body.

In one embodiment, the body can be seen having a base layer 202 of a polypropylene or other thermoplastic polymer composition, at least one print layer 206a-n of a polymeric material and with decorative indicia disposed thereon (wherein “n” represents any number greater than 1), and a bonding print layer 204 having a polymeric bonding agent and interposed between the base layer 202 and the at least one print layer 206a-n with the decorative indicia disposed thereon.

The print layer forming the lower surface is positioned, when desired for use, facing downward and is of or forms a friction-inducing material or gripping surface that has non-slip characteristics. The base layer 104 forming the upper surface of the body is positioned facing upward when in use and may be comprised of a polypropylene or other thermoplastic polymer composition.

FIG. 2 provides a more detailed breakdown of the layers of the cutting mat assembly 100. A base layer 202 is comprised of a polypropylene or other thermoplastic polymer composition operably configured to be cut repeatedly with sharp objects, under forces ranging up to approximately 100 lbf, without completely penetrating the base layer thickness. When in use, the base layer 202 faces upward toward the user and functions as the cutting surface for dicing of produce and various other foodstuffs. An exemplary body 102 thickness range separating the upper surface 104 of the body 102 and the lower surface 106 of the body 102 is approximately between 0.1 millimeters and 2.0 centimeters. This exemplary thickness range provides for flexibility of the cutting mat assembly 100 in that it is operably configured to be bent repeatedly without plastic or permanent deformation. In preferred embodiments, the body 102 is flexible and operably configured to repeatedly bend at least 100 times in an overlapping relationship with itself without plastic deformation, wherein plastic deformation is defined as the permanent distortion that occurs when a material is subjected to tensile, compressive, bending, or torsion stresses that exceed its yield strength and cause it to elongate, compress, buckle, bend, or twist. A thickness greater than 2.0 centimeters may be characterized as a cutting board, as opposed to a cutting mat, but would nevertheless fall within the scope of the present invention, unless specifically limited, as the characterization may be merely one of semantics. Deviations in thickness falling outside the exemplary thickness range will affect the degree of flexibility of the cutting mat assembly 100. The cutting mat assembly 100 may comprise any level of thickness while retaining the slip-resistant and transparent features of the present invention. To that end, the coupling and formation techniques described herein may also be applicable to a more rigid first layer more akin to that of a cutting board. In preferred embodiments, the base layer 202 defines an outer perimeter 108 of the body 102.

In preferred embodiments of the present invention, the base layer 202 is of a sheet-cut composition. In other embodiments, the base layer 202 may be comprised of a mold or outline with injected polypropylene or other thermoplastic polymer composition filling the voids therein. The general shape, form, or outline of the base layer 202 and the cutting mat assembly 100 may vary in accordance with the desired customization of the Inventor.

In an exemplary embodiment, the base layer 202 is of a transparent or translucent material over an area defined by the outer perimeter 108 of the body 102 such that when the cutting mat assembly 100 is in use, the decorative indicia on the at least one print layer 206a-n remains visible to users. The base layer 202 may be nontransparent or opaque in other embodiments, wherein the decorative indicia on the at least one print layer 206a-n are only visible when the cutting mat assembly 100 is turned over.

The cutting mat assembly 100 further comprises a bonding print layer 204 having a polymeric bonding agent and interposed between the base layer 202 and the at least one print layer 206a-n with the decorative indicia disposed thereon. The polymeric bonding agent is designed to permanently bond silicone or other types of rubber to poly materials such as, by way of example and without limitation, polypropylene. In preferred embodiments, the bonding print layer 204 is substantially comprised of a polysiloxane composition, generally known as silicone, or another substantially equivalent material. The bonding print layer 204 may span the entire area of the base layer 202 and the at least one print layer 206a-n or may be less than the area. The area may be defined by the perimeter 108 of the base layer 202 or the at least one print layer 206a-n. The at least one print layer 206a-n are thereafter laid on top of the bonding print layer 204. All layers may be coupled together to be integral, i.e., permanent or semi-permanent and requiring a sufficient external force to separate prematurely. In one embodiment, this integral formation may be done through a curing polymerization process whereby a specific high temperature and pressure is applied to the body 102 for a certain period of time, causing all layers to become coupled but falling short of deforming the layers, e.g., of curling, warping, sinking, or shrinking the layers. The length and temperature of the curing processes varies depending on the thickness of the material or substrate used for the base layer 202, the at least one print layer 206a-n, and the bonding print layer 204, and the viscosity and Shore Hardness Value (“SHV”) of the at least one print layer 206a-n and the bonding print layer 204. Generally, a greater thickness, viscosity, or SHV increases the length of time the integral layup 200 must be cured and the temperature at which the integral layup 200 must be cured. The curing time and temperature must be closely monitored and controlled to avoid plastic deformation of the integral layup 200, e.g., curling or warping. In preferred embodiments, the formation of the body may be through a screen-printing process known by those of skill in the art. See, e.g., Machita et al., U.S. Pat. No. 4,981,074; Baele, U.S. Patent Application Publication No. 2003/0021886; Amao et al., U.S. Pat. No. 4,864,361, the entirety of which is incorporated herein by reference.

The at least one print layer 206a-n is of a polymeric material having a friction-inducing characteristic designed to prevent the cutting mat assembly 100 from substantially moving when in use. In exemplary embodiments, the polymeric material of the least one print layer 206a-n is of a silicone rubber material, or another substantially equivalent material, having a coefficient of friction ranging approximately from 0.5 to more than 1, e.g., 1.5. Lower durometers will have higher coefficients. The texture of the at least one print layer 206a-n may be varied to increase or modify the co-efficient of friction accordingly.

The bonding layer 204 and the at least one print layer 206a-n may have an SHV ranging from SHV A 30 up to, and not exceeding, SHV A 80. The specific SHV of each layer depends on the level required to achieve the desired nonslip quality of the cutting mat assembly 100 and on the level required to achieve adequate resistance to abrasion. The bonding layer 204 and the at least one print layer 206a-n may fall within a varied numerical SHV range where a different SHV grade is utilized or applied thereto.

The bonding print layer 204 and the at least one print layer 206a-n may each have an exemplary thickness range approximately between 0.05 millimeters and 1.0 millimeters. This exemplary thickness range provides for flexibility of the cutting mat assembly 100 in that it is operably configured to be bent repeatedly without plastic or permanent deformation. In other embodiments of the present invention, the bonding print layer 204 and the at least one print layer 206a-n may have thicknesses falling below or above this exemplary thickness range. Deviations in thickness falling outside the exemplary thickness range will affect the degree of flexibility of the cutting mat assembly 100.

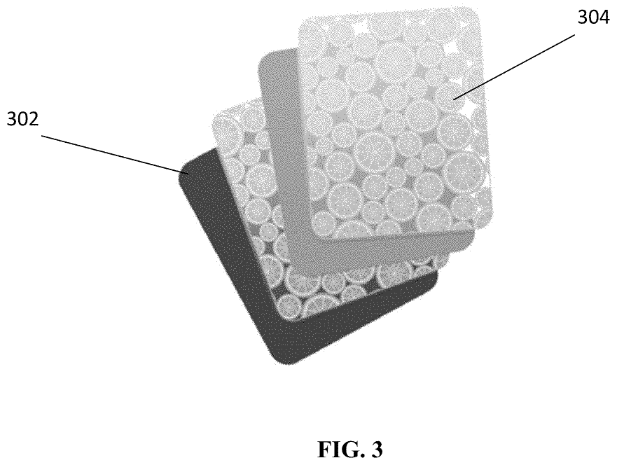

As best seen in the block diagram of FIG. 3, the specific decorative indicia disposed on the at least one print layer 206a-n may be a color, design element, picture, logo, wording, etc., or a plurality or combination of any or all the foregoing. The decorative indicia may be selectively varied and customized during the screen-printing process to suit the taste of the user or manufacturer. In one embodiment, a solid design layer 302 may feature one single solid color characterizing the principal design characteristics. In an alternate embodiment, a pattern design layer 304 may feature a customized pattern or design characterizing the principal design characteristics. The solid design layer 302 and the pattern design layer 304 may each comprise functional prints intended to perform a function, aesthetic prints intended to appeal to the aesthetic taste of users, or both. In one embodiment, the decorative indica makes up at least 50% of an area defined by the outer perimeter 108 of the body 102.

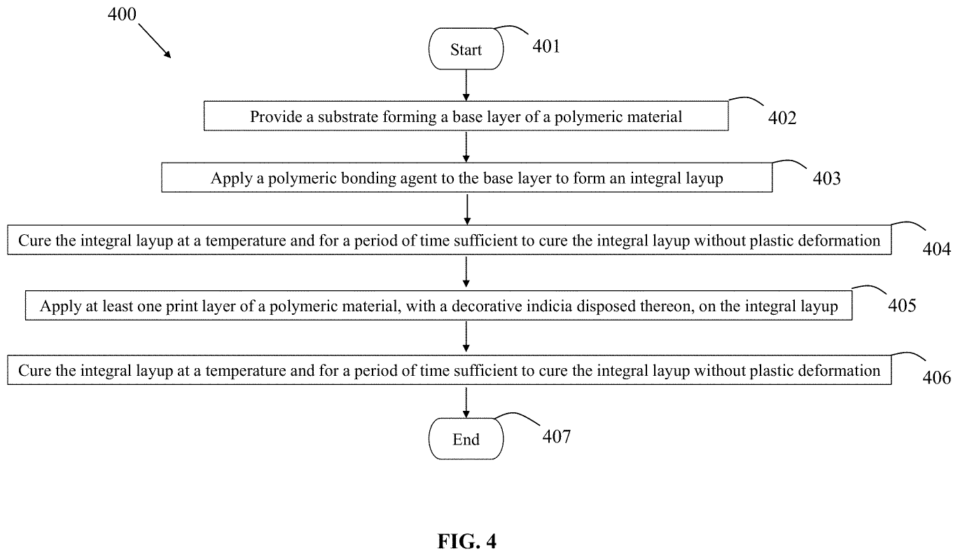

The present invention further provides a novel method 400 for the formation of a non-slip cutting mat assembly 100. As referenced in the block diagram of FIG. 4, the method 400 comprises a sequence of consecutive steps for combining and curing a variety of layers to form the integral layup 200 designed to be used as a cutting surface. The method 400 begins with Steps 401 and 402, whereby Step 402 entails providing a substrate forming the base layer 202 of a polymeric material and defining the upper surface 104 of the body 102 of the integral layup 200. Step 403 comprises applying the polymeric bonding agent to the base layer 202 to form the integral layup 200. The polymeric bonding agent is designed to permanently bond silicone or other types of rubber to poly materials such as, by way of example and without limitation, polypropylene.

A further Step 404 further comprises curing the integral layup 200 at a temperature and for a period of time sufficient to cure the integral layup 200 without plastic deformation of the integral layup 200. Curing causes all layers to become coupled without deforming the layers, e.g., of curling, warping, sinking, or shrinking the layers. The length and temperature of the curing process varies depending on the thickness of the material or substrate used for each of the layers, and the viscosity and SHV of the layers. In an exemplary embodiment, the integral layup 200 is cured at an optimum temperature ranging between 100° F. and 180° F. and for a period of time ranging between 5 minutes and 72 hours. Step 405 entails applying the at least one print layer 206a-n of a polymeric material, with decorative indicia disposed thereon, on the integral layup 200, the at least one print layer 206a-n defining the lower surface 106 of the body 102 of the integral layup 200 and the polymeric material having a friction-inducing characteristic. In exemplary embodiments, the polymeric material of the least one print layer 206a-n is of a silicone rubber material having a coefficient of friction ranging approximately from 0.5 to more than 1, e.g., 1.5. Lower durometers will have higher coefficients. The texture of the at least one print layer 206a-n may be varied to increase or modify the co-efficient of friction accordingly.

Step 406 comprises curing the integral layup 200 at a temperature and for a period of time sufficient to cure the integral layup 200 without plastic deformation of the integral layup 200. Curing causes all layers to become coupled without deforming the layers, e.g., of curling, warping, sinking, or shrinking the layers. The length and temperature of the curing process varies depending on the thickness of the material or substrate used for each of the layers, and the viscosity and SHV of the layers. In an exemplary embodiment, the integral layup 200 is cured at an optimum temperature ranging between 100° F. and 180° F. and for a period of time ranging between 5 minutes and 72 hours. Where multiple print layers 206a-n are applied, the integral layup 200 may be cured once after the application of all the print layers 206a-n on the integral layup 200 or after the application of each print layer 206a-n on the integral layup 200.

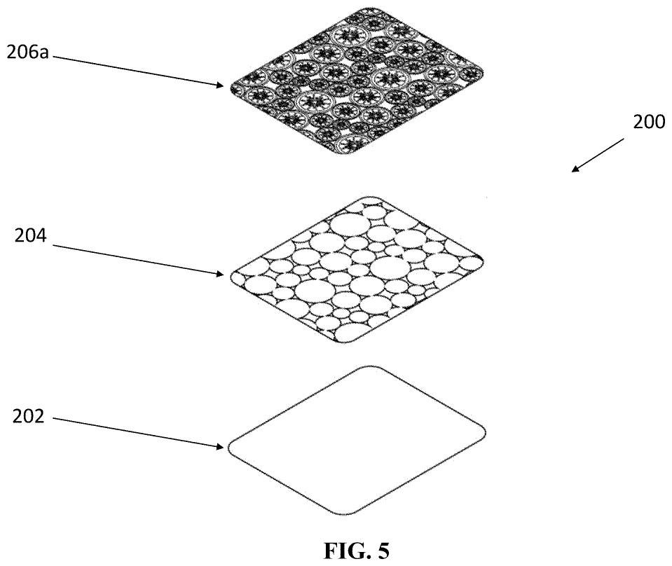

FIG. 5 provides a schematic diagram depicting a preferred layup of the non-slip cutting mat assembly 100 and, specifically, depicting the integral layup 200, the base layer 202, the bonding print layer 204, and the at least one print layer 206a.

What is claimed is:

1. A non-slip cutting mat assembly comprising:
an integral layup forming a body with an upper surface and a lower surface opposing the upper surface of the body, the integral layup having:
a base layer of a polymeric material and defining the upper surface of the body;
at least one print layer of a polymeric material, with decorative indicia disposed thereon, and defining the lower surface of the body, the polymeric material having a friction-inducing characteristic; and
a bonding print layer having a polymeric bonding agent and interposed between the base layer and the at least one print layer with the decorative indicia disposed thereon.

2. The non-slip cutting mat assembly according to claim 1, wherein:
the base layer is of a polypropylene material and the base layer defines an outer perimeter of the body.

3. The non-slip cutting mat assembly according to claim 1, wherein:
the polymeric material of the least one print layer is of a silicone rubber material.

4. The non-slip cutting mat assembly according to claim 1, wherein:
the decorative indica makes up at least 50% of an area defined by an outer perimeter of the body.

5. The non-slip cutting mat assembly according to claim 1, wherein:
the body is flexible and operably configured to repeatedly bend in an overlapping relationship with itself without plastic deformation.

6. The non-slip cutting mat assembly according to claim 1, wherein the body further comprises:
a body thickness separating the upper surface of the body and the lower surface of the body, the body thickness less than approximately 2 cm.

7. The non-slip cutting mat assembly according to claim 1, wherein:
the base layer is of a transparent material over an area defined by an outer perimeter of the body.

8. A method of forming a non-slip cutting mat comprising the steps of:
providing a substrate forming a base layer of a polymeric material and defining an upper surface of a body of an integral layup;
applying a polymeric bonding agent to the base layer to form an integral layup;
curing the integral layup at a temperature and for a period of time sufficient to cure the integral layup without plastic deformation;
applying at least one print layer of a polymeric material, with decorative indicia disposed thereon, on the integral layup, the at least one print layer defining a lower surface of the body of the integral layup and the polymeric material having a friction-inducing characteristic; and
curing the integral layup at a temperature and for a period of time sufficient to cure the integral layup without plastic deformation.

9. The method of forming a non-slip cutting mat according to claim 8, wherein:
the integral layup is cured at a temperature ranging between 100° F. and 180° F.

10. The method of forming a non-slip cutting mat according to claim 8, wherein:
the integral layup is cured for a period of time ranging between 5 minutes and 72 hours.

11. The method of forming a non-slip cutting mat according to claim 8, wherein:
the integral layup is cured after the application of every at least one print layer of a polymeric material.
